(19) United States
(12) Patent Application Publication
(10) Pub. No.: US 2016/0187862 A1
(43) Pub. Date: Jun. 30, 2016

(54) SYSTEMS AND METHODS FOR HOME AUTOMATION VIA A MEDIA DEVICE

(71) Applicant: SLING MEDIA PVT LTD, Bangalore (IN)

(72) Inventor: Madan Mohan Nayak, Keonjhar (IN)

(21) Appl. No.: 14/724,475

(22) Filed: May 28, 2015

Related U.S. Application Data
(60) Provisional application No. 62/097,493, filed on Dec. 29, 2014.

(51) Int. Cl. G05B 15/02; H04L 12/28

(52) U.S. Cl. CPC G05B 15/02; H04L 12/2816

(57) ABSTRACT

A home automation system stores, at a media device, configuration data including an identifier associated with a remotely controllable device. Remote control information is received over a network. From the remote control information and the configuration data, a desired remote control signal is determined. The desired remote control signal is then transmitted from the media device to the remotely controllable device. In this way, a media device (such as a set-top box, place-shifting device, or the like) is capable of controlling devices in its environment.

### CROSS-REFERENCE TO RELATED APPLICATIONS

This application claims priority to U.S. Provisional Patent Application No. 62/097,493, filed Dec. 29, 2014, the entire contents of which are hereby incorporated by reference.

### TECHNICAL FIELD

The present disclosure generally relates to the home automation. More particularly, the following discussion relates to systems, methods, and devices for controlling appliances and other home automation components via a media device.

### BACKGROUND

Due in part to the ubiquity of mobile devices, smart-phones, tablet computers, and the like, as well as a trend toward an “Internet of Things,” home automation has become increasing popular in recent years, allowing users to remotely control appliances, lighting, security systems, and other such controllable devices and systems using a variety of communication protocols, such as WiFi, RF, Zigbee, Z-Wave, BLE, and the Insteon protocol.

While such home automation systems are relatively convenient and effective, many challenges still exist. For example, such systems often require one or more additional electronic components to act as a “base station,” interface, and/or controller. This need for additional components tends to increase power consumption and complexity. Furthermore, the setup of controllable devices in an environment can be time consuming and non-intuitive.

Accordingly, there is a need for improved home automation systems, devices, and techniques. These and other desirable features and characteristics will become apparent from the subsequent detailed description and the claims, taken in conjunction with the accompanying drawings and this background section.

### BRIEF SUMMARY

Several examples of systems, devices, methods, user interfaces are described for controlling appliances and other home automation components using a media device (e.g., set-top box, place-shifting device, or the like) capable of communicating with such devices. A home automation method in accordance with one embodiment includes: storing, at a media device, configuration data including an identifier associated with a remotely controllable device; receiving, over a network, remote control information; determining, from the remote control information and the configuration data, a desired remote control signal; and transmitting the desired remote control signal from the media device to the remotely controllable device.

A home automation system in accordance with one embodiment includes a computing device coupled to a network; a configuration server communicatively coupled to the computing device over the network; a remotely controllable device configured to receive remote control signals; and a media device communicatively coupled to the computing device and the configuration server over the network. The media device is configured to request configuration data from the configuration server, the configuration data including an identifier associated with the remotely controllable device; receive, over the network, remote control information; determine, from the remote control information and the configuration data, a desired remote control signal; and transmit the desired remote control signal to the remotely controllable device.

Alternate embodiments, aspects and other features are described in more detail herein.

### BRIEF DESCRIPTION OF THE DRAWING FIGURES

Exemplary embodiments will hereinafter be described in conjunction with the following drawing figures, wherein like numerals denote like elements, and:

FIG. 1 is a conceptual block diagram illustrating a home automation system in accordance with one embodiment.

FIG. 2 is a flow chart illustrating a method in accordance with one embodiment.

FIG. 3 is a block diagram illustrating a place-shifting system in which the present embodiments may be implemented.

### DETAILED DESCRIPTION

Systems and methods are provided for home automation through the use of a media device that includes a suitable remote control transmitter (e.g., an “IR blaster”). In this way, a component that is already present in the environment (e.g., a set-top box or placeshifting device) can be used to control appliances and other devices in the environment, without requiring additional components. In that regard, the following detailed description of the invention is merely exemplary in nature and is not intended to limit the invention or the application and uses of the invention. Furthermore, there is no intention to be bound by any theory presented in the preceding background or the following detailed description.

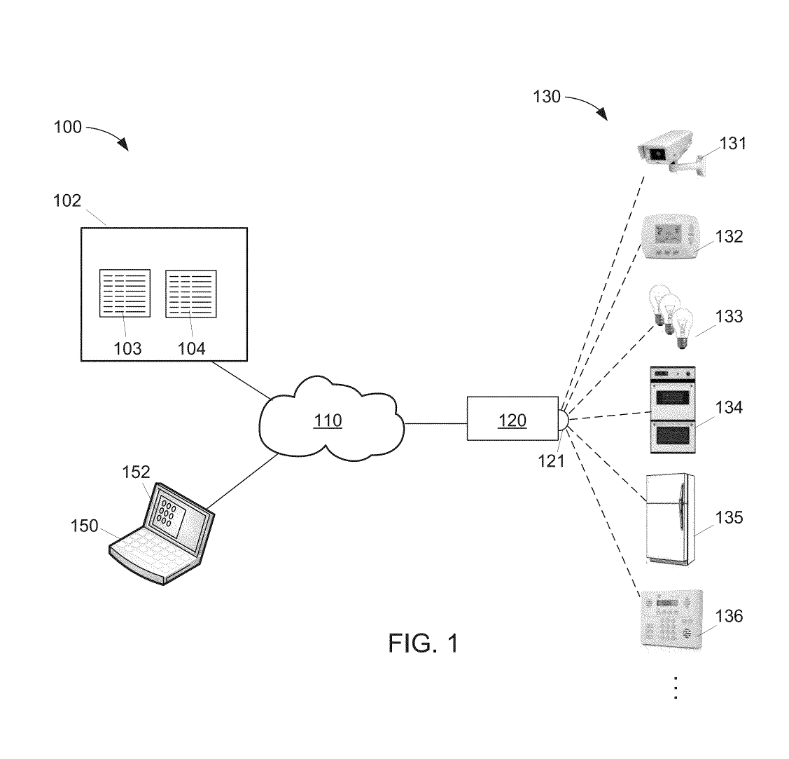

Referring to FIG. 1, a home automation system 100 in accordance with various embodiments generally includes a media device 120 (e.g., a set-top box, place-shifting device, or the like) communicatively coupled over a network 110 to a server 102 and a computing device 150. Media device 120 includes a remote control component 121 configured to transmit appropriate remote control signals to one or more remote controllable devices (or simply “controllable devices”) 130 (e.g., controllable devices 131-136 as illustrated). Computing device 150 is capable of displaying a user interface 152 that provides a virtual remote control or similar graphical display and which, in response to user interaction with user interface 152, is configured to send remote control information to media device 120 over network 110. Media device 120 then transmits the appropriate remote control signal to one of the controllable devices 130 in accordance with the user's interaction with user interface 152. Server 102 includes one or more configuration files 103 that may be requested by computing device 150 to determine the appropriate user interface or “skin” to display for user interface 152. Server 102 also includes remote control data files 104 that may be requested by media device 120 to determine the appropriate remote control signals (e.g., IR signal) to transmit for each controllable device 130. For each controllable device the skin and data file is unique and its determined from, e.g., a four-parameter device type (e.g., a DVD player, a refrigerator, its manufacturer and model, etc.). In this way, a user is able to operate—via a media device 120 that already exists in the environment—controllable devices 130 over network 110 via computing device 150 that is physically remote from controllable devices 130.

Device 120 may correspond to any combination of hardware and software configured to receive and process media content from a content source (not illustrated in FIG. 1), including, for example, a mobile telephone, a computer system (such as desktop computer, laptop computer, tablet computer, or the like), a set top box, a place-shifting device, a television receiver, or a dedicated media player. Similarly, computing device 150 may correspond to any combination of hardware and software configured to display user interface 152, including without limitation any of the components cited above in connection with device 120. While the environment illustrated in FIG. 1 is shown as a single network 110, in practice the environment may include any number of wired and/or wireless network operating within the geographic proximity of a home, office or other structure and that are generally under the control of a single user, family or operator. Although FIG. 1 illustrates a single remote control transmitter 121, the invention is not so limited. Media device 120 may incorporate any number of transmitters having the same or different type.

Controllable devices 130 may include any assembly, device, or electronic component capable of receiving and interpreting a remote control signal transmitted by component 121 of media device 120. In the illustrated embodiment, for example, the controllable devices 130 include a surveillance system 131, a thermostat 132, one or more lighting devices 133, an over 134, a refrigerator 135, and an alarm system 136. The invention is not so limited, however, and contemplates any other remotely controllable device now known or later developed, such as audio speakers, ceiling fans, LAN components, media streaming devices, wall power outlets, irrigation controllers, electrical blinds, and swimming pool components.

Controllable devices 130 may communicate with media device 120 through any suitable protocol. Example home automation protocols include, without limitation, C-Bus, EnOcean, Insteon, KNX, UPB, X10, IR, Zixbee, and Z-Wave. Such protocols are well known in the art, and need not be discussed in detail herein. In one embodiment, remote control component 121 is an infrared transmitter (e.g., an “IR blaster”) as is known in the art. Such a component is particularly advantageous in that media devices such as media device 120 often include such a component for controlling entertainment devices in the environment (e.g., devices within the line-of-sight of component 121).

Configuration data 104 preferably includes, for one of controllable devices 130, a list of functions provided by each device, as well their corresponding remote control signals. Because the functionality of each controllable device 104 can vary, the nature and format of configuration data 104 may also vary widely. In the case of alarm system 136, for example, configuration data 104 might include two functions: “arm” and “disarm,” each having their own associated codes. This information is then suitable formatted and provided to media device 120. Media device 120 may store the received configuration data in a variety of formats and data structures, such as an IR “.bin” file, as is known in the art.

Configuration data 103 preferably includes graphical information or “skins” associated with a virtual remote control to be used with the associated controllable device 131. For example, in the case of thermostat 132, user interface 152 might include a graphical display that mimics the physical appearance of (and allows graphical manipulation of) a form of “virtual” thermostat. In other embodiments, more general user interface components are used, much in the way that universal remote control devices may be used for multiple entertainment devices.

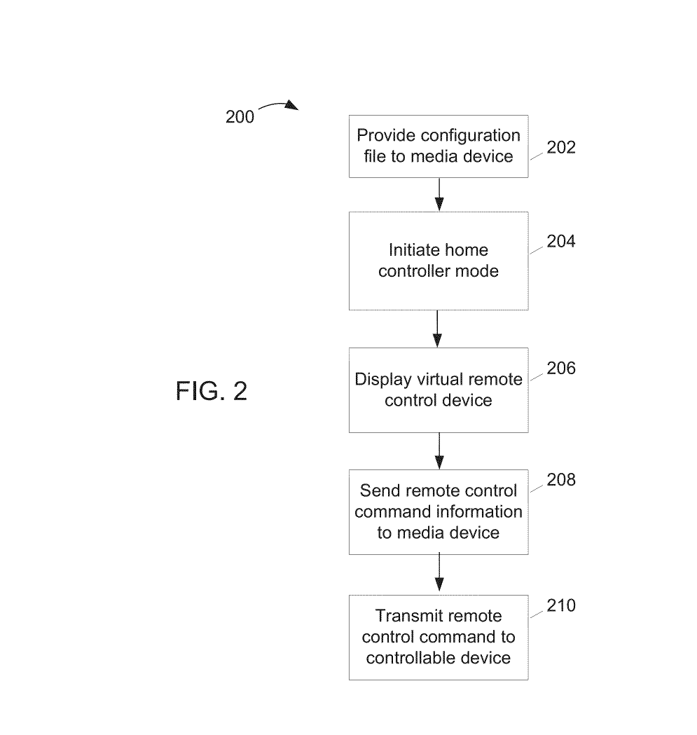

FIG. 2 presents a flow-chart depicting a method 200 of home automation in accordance with one embodiment. Referring to FIG. 2 in conjunction with the block diagram of FIG. 1, initially, at step 202, the appropriate configuration files 104 are provided to media device 120 for the controllable devices 130 present within the environment. This may be accomplished, for example, by media device 120 requesting (over network 110) configuration data based on user interaction with a user interface provided by media device 120 or the computing device 150 can request the file from 102 server and upload to media device 120. That is, media device 120 may present a “wizard” or other interactive user interface that allows the user to specify the make, model, type, and/or other information related to each controllable device 130, and media device 120 then requests that information from server 102. Otherwise computing device 150 can fetch the configuration data from server 102 and send it to media device 120. Server 102, upon receiving the request, determines (through a look-up table or other such data structure) the appropriate configuration data to send to media device 120. Thus, for example, the user may specify that refrigerator 135 is a Model 2142 General Electric refrigerator. Server 102 will then search configuration data 104 and send the appropriate file or files to media device 120. As mentioned above, configuration data 104 will generally include the remote control codes appropriate for that device.

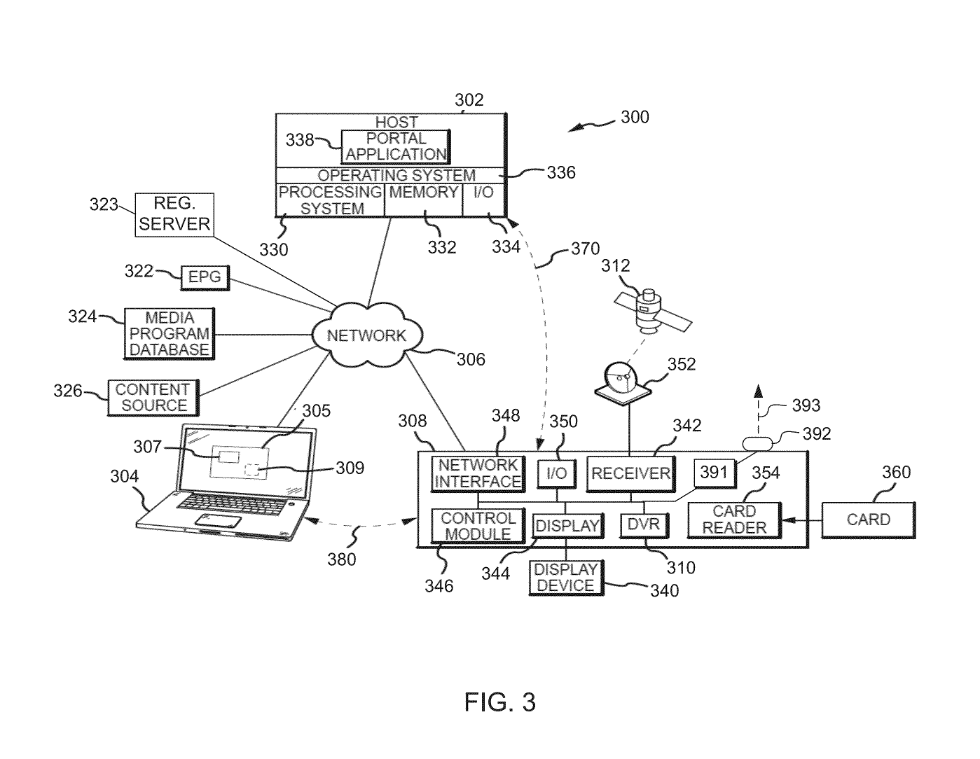

Next, at step 204, when the user wants to control a device remotely, he first connects to media device 120 and then initiates a home controller mode at computing device 150. This may be accomplished, for example, by the user selecting a “My Home Controller Input” tab or the like provided by software running on computing device 150. In the context of place-shifting media content (described in further detail in conjunction with FIG. 3 below), for example, the user may initiate the home controller mode while viewing media content on a display of computing device 150. After switching to “My Home Controller” input, the media device 120 provides the list of configured device from which user can select the device he wants to control

In response to the user entering the home controller mode and selecting the device to control, the computing device 150 requests the skin files 103 from server 102, then a virtual remote control device or other user interface 152 is presented to the user (step 206). The computing device 150 can then store the skin file for subsequent use. The graphical components of such a user interface 152 may be specified by one or more graphics files residing on server 102 and downloadable by computing device 150. In the case of refrigerator 135, for example, computing device may know a priori (or download only when needed) the appropriate buttons and controls to be used for that device (e.g., buttons associated with “increase temperature,” “decrease freezer temperature,” and the like.

In response to user interaction with user interface 152 (e.g., the clicking of a button intended to increase temperature), computing device 150 then sends, at step 208, the remote control information over network 110 to media device 120. The remote control information may have a variety of formats and content, depending upon the nature of the associated controllable device 130. In one embodiment, for example, the remote control information includes controllable device index and code associated with the requested function, which can then be understood by media device 120 by virtue of the configuration file(s) downloaded and stored previously.

Finally, in step 210, the appropriate remote control command (e.g., an IR signal) is transmitted to the appropriate controllable device 130. Continuing with the previous example, media device 120 uses the previously downloaded configuration files and looks up the code associated with the requested function (“increase temperature”), then determines the correct remote control command (e.g., a series of IR pulses) to send via component 121.

The above systems and methods may be implemented in the context of a wide variety of entertainment devices and systems. FIG. 3 depicts one, non-limiting, example: a system 300 for placeshifting or otherwise transferring data or content, such as a media program (or media content), from a source electronic device 308 to a destination electronic device 304 over a network 306 for presentation to a user (or viewer) on the destination electronic device 304. Thus, media content source 326 of FIG. 1 may be implemented as content source 326, and media device 120 of FIG. 1 may correspond to device 308. For purposes of explanation, but without limitation, the source device 308 may be alternatively referred to herein as a media device or a placeshifting device, and the destination electronic device 304 may be alternatively referred to herein as a playback device or a client device (or client). Media device 308 may thus correspond to media device of FIG. 1, and thus may also one or more remote control devices 392 configured to transmit a remote control signal (e.g., an IR or RF signal) 393 as commanded by a suitable remote control module 391.

The placeshifting system 300 also includes a host server 302 (or host) that communicates or otherwise interacts with the devices 304, 308 over the network 306 to facilitate establishment of a peer-to-peer connection 380 over the network 306, which may be utilized for a placeshifting session, as described in greater detail below. It should be understood that FIG. 3 is a simplified representation of the placeshifting system 300 for purposes of explanation is not intended to limit the subject matter described herein in any way.

In practice, the client device 304 may be any device, component, module, hardware and/or the like that is capable of communicating with the server 302 over network 306. For example, depending on the embodiment, client device 304 may be realized as a conventional personal computer, portable computer, a tablet computer, workstation and/or other computing system, a mobile (or cellular) telephone, a smartphone, a personal digital assistant, a video game player, and/or any other device capable of receiving media programs via the network 306 and presenting audio and/or visual content. In this regard, the client device 304 includes a display device, such as a monitor, screen, or another conventional electronic display, capable of graphically presenting visual content, data and/or information that is generated or otherwise provided by an application 305, 307 executing on the client 304. The client device 304 may further include a user input device, such as a keyboard, a mouse, a touchscreen, or the like, capable of receiving input data and/or other information from the user of the client device 304. The client device 304 also includes a processing system and a data storage element (or memory) that is coupled to or otherwise accessed by the processing system and stores programming instructions that, when read and executed, cause the processing system of the client device 304 to generate one or more applications 305, 307, 309 executing thereon and perform various tasks, functions, processes and/or operations and support the subject matter described herein. The processing system may be realized as any sort of processor, microprocessor, microcontroller, digital signal processor, or any other suitable processing device, or any suitable combination thereof.

The client 304 may reside at a geographic location that is remote or otherwise physically distinct from the geographic location of the media device 308. In this regard, the media device 308 may have an essentially fixed or permanent geographic location, whereas the geographic location of the client 304 may be transient or otherwise variable with respect to the location of the media device 308. For example, the media device 308 may be realized as a set-top box or a similar device that resides at a user's home for providing media content to the user's television or other home display device 340, while the client 304 is realized as a portable electronic device, such as a mobile phone or other mobile computing device, that moves about with the user.

In the embodiment shown in FIG. 3, client device 304 executes a conventional browser or other client application 305 that is compatible with standard Internet, world wide web (WWW), transmission control protocol, and/or Internet Protocol (TCP/IP), and/or other formats. Such browsers are typically capable of displaying active or other documents formatted in accordance with published protocols and/or computer languages (e.g., hypertext markup language (HTML), extensible markup language (XML), cascading style sheets (CSS), Javascript, and/or the like). Many browsers are also capable of executing “plugin” applications, applets or the like. Such plugins may be formatted in accordance with ActiveX, JAVA, Javascript and/or any number of other formats. A number of commonly used web browsers are available for a number of different computing platforms, and the subject matter described herein is not limited to any particular browser application. In the illustrated embodiment, client 304 further includes a media player application 307. The media player 307 may be a standalone media player, or the media player 307 may be implemented as a plugin or other applet that runs within the client application 305 as desired. In some embodiments, media player 307 is initially obtained from a networked host, such as server 302. The media player 307 may be retrieved on an as-needed basis in some embodiments, or may be stored at client 304 for subsequent execution.

With continued reference to FIG. 3, in exemplary embodiments, media device 308 is any form of device, module, component, hardware and/or the like capable of receiving and processing media content from one or more content sources. For example, in some embodiments, media device 308 is a set-top box (STB) or similar system that is able to receive television programming and/or to record certain programs that can be viewed on a display device 340, such as a television, monitor, liquid crystal display (LCD), light emitting diode (LED) display, plasma display, or the like. Exemplary embodiments of media device 308 will therefore include or otherwise be coupled to a receiver interface 342 for receiving satellite, cable and/or broadcast programming signals from broadcast sources 312, as well as a data storage medium 310 (e.g., a hard disk, flash memory, or another suitable non-volatile data storage element) to support a digital video recorder (DVR) feature and/or functionality, a display interface 344 for providing imagery to the display device 340, and a control module 346 that directs the operations of the media device 308 as appropriate. For convenience, but without limitation, the data storage medium 310 is alternatively referred to herein as a DVR. Media device 308 may also include one or more interfaces 348 to the network 306 and/or an input/output interface 350 to a remote control or other device for providing user inputs to the media device 308, as appropriate. For example, the network interface(s) 348 of the media device 308 may include an interface or port for a wired communications layer (e.g., an Ethernet port or adapter), an interface for a wireless communications layer (e.g., an IEEE 802.11-compatible transceiver), and/or the like.

The components in media device 308 may be provided within a common chassis or housing as depicted in FIG. 3, although equivalent embodiments may implement media device 308 with any number of inter-connected but discrete components or systems. For example, in some embodiments, the media device 308 may be realized as a combination of a STB and a placeshifting device, wherein some features of the media device 308 (e.g., the DVR 310, the receiver 342, the display interface 344, and/or I/Os 350) are implemented by the STB and other features of the media device 308 (e.g., the network interface 348) are implemented by the placeshifting device, wherein the placeshifting device works in conjunction with the STB to shift the viewing experience from a home television (e.g., display device 340) to a viewing display on the client device 304 that is accessed via the network 306. Examples of placeshifting devices that may be used in some embodiments of media device 308 could include any of the various SLINGBOX products available from Sling Media of Foster City, Calif., although other products or servers could be used in other embodiments. Many different types of placeshifting devices are generally capable of receiving media content from an external source, such as any sort of DVR or STB, cable or satellite programming source, DVD player, and/or the like. In other embodiments, placeshifting features are incorporated within the same device that provides content-receiving or other capabilities. Media device 308 may be a hybrid DVR and/or receiver, for example, that also provides transcoding and placeshifting features. It should be appreciated that FIG. 3 depicts merely one exemplary embodiment of a media device 308, and in practice, the media device 308 may be logically and physically implemented in any manner to suit the needs of a particular embodiment.

In the exemplary embodiment illustrated in FIG. 3, media device 308 is capable of receiving digital broadcast satellite (DBS) signals transmitted from a broadcast source 312, such as a satellite, using an antenna 352 that provides received signals to the receiver 342. Equivalent embodiments, however, could receive programming at receiver 342 from any sort of cable connection, broadcast source, removable media, network service, external device and/or the like. In some embodiments, the media device 308 may also include an access card interface or card reader 354 adapted to receive an access card 360 (or viewing card) configured to ensure that the viewer is authorized to view media content provided to the primary display device 340. In this regard, the access card 360 includes unique identification information associated with a particular subscriber to the broadcast content source 312 or otherwise includes subscription information that facilitates receiving and/or decoding media content provided by the broadcast content source 312.

The DVR 310 feature stores recorded programming (e.g., recorded broadcast programming received via receiver 342) on a hard disk drive, memory, a networked server, or other storage medium as appropriate in response to user/viewer programming instructions, wherein the recorded programming may be subsequently viewed via the media device 308, either on display device 340 or client device 304 via network 306. Content stored in DVR 310 may be any sort of file-based programming or other content that is accessible to media device 308. In various embodiments, in addition to storing broadcast programming, the DVR 310 may also store programming received from other sources not illustrated in FIG. 3, such as, for example, programming downloaded from an on-demand programming source or an online programming source. Additionally, content in DVR 310 may be stored in any sort of compressed or uncompressed format, as desired, and may be encoded or transcoded as desired for effective receipt, storage, retrieval and playing.

The control module 346 is any sort of hardware, circuitry, processing logic and/or other components capable of directing the operations of media device 308. In various embodiments, control module 346 includes software or firmware logic and/or other programming instructions residing in memory and executing on any sort of processing system, such as any sort of processor, microprocessor, microcontroller, digital signal processor or the like. The instructions, when read and executed, cause the control module 346 to perform various tasks, functions, processes and/or operations and otherwise support the subject matter described herein. In various embodiments, the control module 346 is based upon a “system on a chip” (SoC) implementation that incorporates a hybrid microcontroller with memory, input/output and other features to perform the various signal processing and other actions of media device 308. Other embodiments may implement control module 346 and/or the other features of media device 308 with any number of discrete and/or integrated processing components (e.g., any sort of microprocessor or microcontroller), memories, input/output features and/or other features as desired. The control module 346 communicates with the network interface 348 to establish a peer-to-peer connection 380 to the client device 304 over the network 306 and support streaming of media programs (e.g., from the DVR 310 or the receiver 342) to the client device 304 over the network 306 via the peer-to-peer connection 380, as described in greater detail below.

In the embodiment of FIG. 3, the network 306 is any communications network (or a combination of communications networks) capable of transmitting data between devices within the system 300. In various embodiments, network 306 includes any number of public or private data connections, links or networks supporting any number of communications protocols. Network 306 may include the Internet, for example, or any other network. Such networks may be based upon TCP/IP or other conventional protocols, although other embodiments may use any type of alternate or successor protocols, as desired. In various embodiments, network 306 may also incorporate a wireless and/or wired telephone network, such as a cellular communications network for communicating with mobile phones, personal digital assistants, and/or the like. Various embodiments of network 306 may also incorporate any sort of wireless or wired local area networks (LANs), wide area networks (WAN), or the like.

In the illustrated embodiment of FIG. 3, the server 302 may be realized as one or more server computers or other device(s) coupled to the network 306 and capable of interacting with the devices 304, 308 to facilitate communications between the client device 304 and the media device 308 associated with the user or operator of the client 304. The server 302 may be implemented with a server computer system or data processing system that is based upon any processor, architecture and/or operating system, and will typically be implemented using a processing system 330, memory 332, and input/output features 334. Various embodiments may be implemented using dedicated or shared hardware servers; other implementations may make use of virtual server features as part of a “cloud computing” service, such as any of the cloud computing services provided by any number of providers.

While FIG. 3 illustrates a single server 302, many practical embodiments of the system 300 may provide a cluster or other collection of multiple host servers 302 to support any desired number of simultaneous communications with multiple clients 304 and/or multiple media devices 308. This cluster may also incorporate appropriate routing, load balancing, access and security mechanisms and or any number of other features. In various embodiments, each server 302 is an actual or virtual computer system executing an operating system 336 in conjunction with the processing system 330, memory 332 and/or I/O features 334 to provide a computing core that is capable of executing a portal application 338, as well as any number of daemons, processes, applications or other modules as desired. For example, a portal application 338 could execute as a daemon on the server 302, with connections to separate clients 304 being managed as separate processes or instances that communicate with portal application 338 using features provided by operating system 336. In one or more embodiments, the memory 332 stores programming instructions that, when read and executed, cause the processing system 330 to create, generate, or otherwise facilitate the portal application 338 and perform various tasks, functions, processes and/or operations described herein. In this regard, the memory 332 represents any non-transitory short or long term data storage element or other computer-readable media capable of storing programming instructions for execution by or on the processing system 330.

The user of the client 304 is able to connect to the portal application 338 supported by host 302 via the network 306, for example, by directing the client application 305 to a URL or other network address associated with host 302 and/or portal application 338. In exemplary embodiments, after the user is successfully authenticated by the portal application 338, and he gets the the connection parameter associated with device 308. Using the connection info client 305 establish a channel 380 which is used to stream media data and to and fro communication. Thereafter, the client 304 utilizes the connection 380 to obtain, from the media device 308 via the network 306, information about programming stored at the media device 308 and available for placeshifting to the client device 304, such as, for example, a listing of the media programs stored on DVR 310. It should be noted that although FIG. 3 depicts the network connection 380 as being between the host 304 and the media device 308, in practice, the placeshifting system 300 may include one or more intermediary components (e.g., one or more message servers or relay server) configured to establish, facilitate, or otherwise support the connection 380.

Server 302 is coupled to an electronic program guide 322, which may be realized as a server, a database, or another device operating on the network 306 that maintains information pertaining to current and/or future broadcasts (or airings) of media programs that are available to be received from broadcast source 312 (e.g., by the media device 308 via receiver 342 and/or antenna 352). The server 302 and/or the portal application 338 may obtain information pertaining to current and/or future broadcasts (or airings) of media programs from the electronic program guide 322 and generate or otherwise provide a program guide graphical user interface (GUI) display on the client device 304 (e.g., within client application 305) that indicates media programs that are or will be available for streaming from the media device 308. The user of the client device 304 may manipulate or otherwise utilize the graphical user interface (or the graphical user interface elements contained therein) to select or otherwise identify media programs for streaming to the client device 304 and/or recording to the DVR 310. The user may pause or otherwise stop presentation of the streamed media program and manipulate or otherwise operate the client application 305 to transmit or otherwise provide, via the network 306, a request for content to a third-party content source 326 (e.g., a third-party website). The third-party content source 326 responds to the request by transmitting or otherwise providing content to the client device 304 via the network 306.

In the illustrated embodiment of FIG. 1, the placeshifting system 300 also includes a media program database 324 that includes verified or validated metadata and/or other descriptive information for a vast array of media programs. For example, the media program database 324 may contain metadata and/or other descriptive information pertaining to substantially all of the media programs that may be available from one or more content sources within placeshifting system 300 (e.g., information pertaining to any media programs that have previously been aired by a broadcast source 312, along information pertaining to any movie that has been presented in theaters, made available on-demand, or released for individual use (e.g., on digital video disc (DVD) or the like)). In exemplary embodiments, for each media program having a record (or entry) in the media program database 324, the media program database 324 maintains a media data object that includes one or more fields of metadata associated with that media program along with one or more fields of program identifiers that may be used to identify that media program record. In this regard, the program guide 322 and the media program database 324 may utilize the same program identifiers to uniquely identify each media program.

Placeshifting system 300 may also include a registration server 323, as illustrated. After authentication and connection parameters are provided by server 302, either server 302 or 305 can fetch the appropriate registration information. The media device may registers itself with registration server 323 over network 306. As part of registration, the media device communicates its own unique ID and a port that the device “listens” to. The registration server 323 knows the device ID, its public IP address, and the port number with which it listens. This process may be periodic so that any change in the public IP address or port would be reflected in registration server 323.

Many other modifications and enhancements could be provided in a wide array of alternate but equivalent embodiments. The term “exemplary” is used herein to represent one example, instance or illustration that may have any number of alternates. Any implementation described herein as exemplary is not necessarily to be construed as preferred or advantageous over other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of elements described without departing from the scope of the claims and their legal equivalents.

What is claimed is:

1. A home automation method comprising:
storing, at a media device, configuration data including an identifier associated with a remotely controllable device;
receiving, over a network, remote control information;
determining, from the remote control information and the configuration data, a desired remote control signal; and
transmitting the desired remote control signal from the media device to the remotely controllable device.

2. The method of claim 1, wherein the remote control signal is an infrared light signal.

3. The method of claim 1, wherein the media device is a place-shifting device.

4. The method of claim 1, further including selecting the configuration data based on interaction with a user.

5. The method of claim 1, further including displaying, via the media device, a graphical depiction of a remote control device based on the configuration data.

6. The method of claim 1, wherein the remote control signal is selected from the group consisting of Zigbee signals, Z-Wave signals, Insteon Signals, and X10 signals.

7. The method of claim 1, wherein the configuration data includes a list of functions provided by each of the remotely controllable devices.

8. The method of claim 1, wherein the configuration data is an IR .bin file.

9. A home automation system comprising:
a computing device coupled to a network;
a configuration server communicatively coupled to the computing device over the network;
a remotely controllable device configured to receive remote control signals;
a media device communicatively coupled to the computing device and the configuration server over the network, wherein the media device is configured to:
request configuration data from the configuration server, the configuration data including an identifier associated with the remotely controllable device;
receive, over the network, remote control information;
determine, from the remote control information and the configuration data, a desired remote control signal; and
transmit the desired remote control signal to the remotely controllable device.

10. The system of claim 9, wherein the remote control signal is an infrared light signal.

11. The system of claim 9, wherein the media device is a place-shifting device.

12. The system of claim 9, further including selecting the configuration data based on interaction with a user.

13. The system of claim 9, further including displaying, via the media device, a graphical depiction of a remote control device based on the configuration data.

14. The system of claim 9, wherein the remote control signal is selected from the group consisting of Zigbee signals, Z-Wave signals, Insteon Signals, and X10 signals.

15. The system of claim 9, wherein the configuration data includes a list of functions provided by each of the remotely controllable devices.

16. The system of claim 9, wherein the configuration data is an IR .bin file.

17. Non-transitory computer-readable media bearing software instructions that, when executed by a processor, cause the processor to perform a home automation method comprising:
storing configuration data including an identifier associated with a remotely controllable device;
receiving, over a network, remote control information;
determining, from the remote control information and the configuration data, a desired remote control signal; and
instructing a media device to transmit the desired remote control signal to the remotely controllable device.

18. The non-transitory computer-readable media of claim 17, wherein the remote control signal is an infrared light signal.

19. The non-transitory computer-readable media of claim 17, wherein the media device is a place-shifting device.

20. The non-transitory computer-readable media of claim 17, wherein the software instructions further instruct the processor to select the configuration data based on interaction with a user.
